(19) United States
(12) Patent Application Publication
(10) Pub. No.: US 2007/0076322 A1
(43) Pub. Date: Apr. 5, 2007

(54) Slider, head gimbal assembly and hard disc drive

(75) Inventors: Ho-Joong Choi, Suwon-si (KR); Sung-Chul Hur, Suwon-si (KR); Young-Min Ku, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD, Suwon-si (KR)

(21) Appl. No.: 11/352,262

(22) Filed: Feb. 13, 2006

(30) Foreign Application Priority Data
Oct. 4, 2005 (KR) 10-2005-0092971

(51) Int. Cl. G11B 5/60

(52) U.S. Cl. 360/234.4

(57) ABSTRACT

A slider, a head gimbal assembly and a hard disc drive. The slider includes a write element, a read element, a ground wire supplying a ground voltage, a connection pad connected to the ground wire and a ground pad of a suspension interconnect, and a passive element. The passive element which is formed of a capacitor and/or a resistor is connected between the ground wire and the connection pad. The head gimbal assembly includes the slider and the hard disc drive includes the head gimbal assembly.

### CROSS-REFERENCE TO RELATED APPLICATION

This non-provisional application claims priority under 35 U.S.C. 119 to Korean Patent Application No. 10-2005-0092971, filed on Oct. 4, 2005, in the Korean Intellectual Property Office (KIPO), the entire content of which is incorporated herein by reference.

### BACKGROUND OF THE INVENTION

1. Field of the Invention

The present invention relates to an apparatus for reducing the influence of EMI (Electro-Magnetic Interference) and ESD (electrostatic discharge), and more particularly, to a slider for reducing EMI and withstanding ESD, a head gimbal assembly having the slider, and a hard disc drive having the head gimbal assembly.

2. Description of Related Art

Hard disc drive (referred to as “HDD” hereinafter) is an example of data storage device used to store computer programs and data. An HDD comprises a plurality of magnetic heads for writing/reading data into/from a disc. The plurality of magnetic heads respectively magnifies the disc surface and detect magnetic field on the disc surface to write and read data.

Typically, the head comprises a write element (also called write head) for magnifying a disc and a read element (also called read head) for detecting magnetic field.

The slider comprises a write element and a read element and is attached to a suspension interconnect (also called a “suspension”) to form a sub assembly, called head gimbal assembly (HGA). The suspension interconnect connects the slider to a pre-amplifier. Typically, the suspension interconnect includes at least one pair of write wirings (also called a “trace”) and at least one pair of read wirings.

When data is written on a disc, an electric current from the pre-amplifier is transmitted to the write element of the slider through write wirings and when data is read from the disc, signals read by the read element are transmitted to the pre-amplifier through read wirings.

Recently, capacity and operation speed of HDD have rapidly increased and thus, TPI (track per inch) and BPI (bit per inch) is increased and operation frequency used upon write operation and read operation is raised.

Also, AZL (adaptive zone layout) conforming to features of the magnetic head of HDD is introduced and subsequently, operating frequency distribution of HDD is diversified. As the operating frequency of HDD is increased and HDD uses various frequencies, there is a problem in the EMC (Electro-Magnetic Compatibility) approval of an HDD-mounted set.

Further, in order to achieve a higher recording density, the read element (or ‘read head’) is designed to have a smaller size and a higher sensitivity. Accordingly, the read head is weak to external noise such as ESD.

FIG. 1A schematically shows the structure of a conventional head gimbal assembly comprising a slider 11 and a suspension interconnect 13 and FIG. 1B shows an equivalent circuit diagram of the head gimbal assembly shown in FIG. 1A, in which R and C represent a parasitic resistor and a parasitic capacitor, respectively, generated by a conductive epoxy 15.

Referring to FIG. 1A and FIG. 1B, the slider 11 and the suspension interconnect 13 of the head gimbal assembly 10 are connected to each other via the conductive epoxy 15. A ground wire for supplying a slider ground voltage VSS1 to the slider 11 and a ground wire for supplying a suspension interconnect ground voltage VSS2 to the suspension interconnect 13 are connected through the parasitic resistor R and the parasitic capacitor C.

However, the resistance of the parasitic resistor R generated by the conductive epoxy 15, that is the resistance between the slider 11 and the suspension interconnect 13, is so great that the common-mode noise produced upon the writing operation cannot be effectively eliminated. Accordingly, there is proposed a structure for reducing EMI by effectively eliminating the common-mode noise produced upon the writing operation, as shown in FIG. 2A.

FIG. 2A schematically shows the structure of a conventional head gimbal assembly comprising a slider and a suspension interconnect and FIG. 2B shows an equivalent circuit diagram of the head gimbal assembly shown in FIG. 2A.

Referring to FIG. 2A and FIG. 2B, a slider ground wire 27 in the slider 21 and a ground pad 25 of the suspension interconnect 29 are connected to each other through a connection pad (also called ‘fifth pad’) 23 and the ground wire 27 of the slider 21 is also connected to a ground wire for supplying a suspension interconnect ground voltage VSS2 to the suspension interconnect 29 through a parasitic resistor R and a parasitic capacitor C.

Therefore, the common-mode noise flows out to the ground voltage (or ground potential: VSS2) through the ground pad 25 of the suspension interconnect 29. However, ESD such as noise of a DC component and noise of a low frequency component inputted through the ground pad 25 of the suspension interconnect 29 are directly delivered to the slider 21, particularly the read element, through the connection pad 23 and thus, the read element of the slider 21 is vulnerable to such ESD.

### BRIEF SUMMARY

An aspect of the present invention provides a slider, a head gimbal assembly and a hard disc drive for reducing EMI emission and improving ESD immunity.

According to an aspect of the present invention, there is provided a slider comprising a read element, a write element, a ground wire, a connection pad to be connected to a ground pad of a suspension interconnect and a passive element connected between the ground wire and the connection pad. The passive element is formed of a capacitor or a resistor.

According to another aspect of the present invention, there is provided a head gimbal assembly comprising a suspension interconnect comprising at least one pair of write wirings, at least one pair of read wirings and a ground pad for supplying a suspension ground voltage, and a slider comprising a write element connected to the at least one pair of the write wirings, a read element connected to the at least one pair of the read wirings, a connection pad connected to the ground pad, a ground wire for supplying a slider ground voltage and a passive element connected between the ground wire of the slider and the connection pad.

According to still another aspect of the present invention, there is provided a head gimbal assembly comprising a suspension interconnect comprising at least one pair of write wirings, at least one pair of read wirings and a ground pad for supplying a suspension ground voltage, a slider comprising a write element connected to the at least one pair of the write wirings, a read element connected to the at least one pair of the read wirings, a ground wire for supplying a slider ground voltage and a connection pad connected to the ground wire, and a passive element connected between the ground pad and the connection pad.

According to yet another aspect of the present invention, there is provided a head gimbal assembly comprising a pre-amplifier ground wire for supplying a pre-amplifier ground voltage to a pre-amplifier, a suspension interconnect comprising a write wiring, a read wiring and a ground pad for supplying a suspension ground voltage, a slider comprising a write element connected to the write wiring, a read element connected to the read wiring, a slider ground wire for supplying a slider ground voltage and a connection pad connected to the pre-amplifier ground wire and the slider ground wire, and a passive element connected between the ground pad and the connection pad, in which the pre-amplifier amplifies data read by the read element and transmits signals amplified for writing to the write element. The suspension interconnect may further comprise a FOD (flying height on demand) ground wire or a DSA (Dual servo actuator) ground wire, in which the FOD ground wire or the DSA ground wire is connected to the connection pad.

According to a yet another aspect of the present invention, there is provided a head gimbal assembly comprising a pre-amplifier ground wire for supplying a pre-amplifier ground voltage to a pre-amplifier, a suspension interconnect comprising a write wiring, a read wiring and a ground pad for supplying a suspension ground voltage, and a slider comprising a write element connected to the write wiring, a read element connected to the read wiring, a slider ground wire for supplying a slider ground voltage, a first connection pad connected to the pre-amplifier ground wire and the slider ground wire, a second connection pad connected to the pre-amplifier ground wire and a passive element connected between the slider ground wire and the second connection pad, in which the pre-amplifier amplifies data read by the read element and transmits signals amplified for writing to the write element.

According to a further aspect of the present invention, there is provided a hard disc drive comprising a disc, and a slider comprising a read element for reading data recorded on the disc a write element for recording data on the disc, a ground wire, a connection pad to be connected to a ground pad of a suspension interconnect and a passive element connected between the ground wire and the connection pad.

According to a further aspect of the present invention, there is provided a hard disc drive comprising a disc and a head gimbal assembly. The head gimbal assembly comprises a suspension interconnect comprising at least one pair of write wirings, at least one pair of read wirings and a ground pad for supplying a ground voltage, and a slider comprising a read element connected to the at least one pair of the read wirings for reading data stored in the disc, a write element connected to the at least one pair of the write wirings for recording data on the disc, a connection pad to be connected to the ground pad of the suspension interconnect, a ground wire for supplying a slider ground voltage and a passive element connected between the ground wire and the connection pad of the slider.

According to a further aspect of the present invention, there is provided a hard disc drive comprising a disc and a head gimbal assembly. The head gimbal assembly comprises a suspension interconnect comprising at least one pair of write wirings, at least one pair of read wirings and a ground pad for supplying a suspension interconnect ground voltage, a slider comprising a write element connected to the at least one pair of the write wirings, a read element connected to the at least one pair of the read wirings and a connection pad connected to a slider ground pad of the suspension interconnect, and a passive element connected between the ground pad of the suspension interconnect and the connection pad, in which the passive element is disposed in the suspension interconnect.

According to a further aspect of the present invention, there is provided a hard disc drive comprising a disc and a head gimbal assembly. The head gimbal assembly comprises a pre-amplifier ground wire for supplying a pre-amplifier ground voltage to a pre-amplifier, a suspension interconnect comprising a write wiring, a read wiring and a ground pad for supplying a suspension ground voltage, a slider comprising a write element connected to the write wiring for recording data in the disc, a read element connected to the read wiring for reading data recorded in the disc, a slider ground wire for supplying a slider ground voltage and a connection pad connected to the pre-amplifier ground wire and the slider ground wire, and a passive element disposed in the suspension interconnect and connected between the ground pad and the connection pad, in which the pre-amplifier amplifies data read by the read element and transmits signals amplified for writing to the write element.

According to a further aspect of the present invention, there is provided a hard disc drive comprising a disc and a head gimbal assembly. The head gimbal assembly comprises a pre-amplifier ground wire for supplying a pre-amplifier ground voltage to a pre-amplifier, a suspension interconnect comprising a write wiring, a read wiring and a ground pad for supplying a suspension ground voltage, and a slider comprising a write element connected to the write wiring for recording data in the disc, a read element connected to the read wiring for reading data recorded in the disc, a slider ground wire for supplying a slider ground voltage, a first connection pad connected to the pre-amplifier ground wire and the slider ground wire, a second connection pad connected to the pre-amplifier ground wire and a passive element connected between the slider ground wire and the second connection pad, in which the pre-amplifier amplifies data read by the read element and transmits signals amplified for writing to the write element.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1A schematically shows the structure of a conventional head gimbal assembly comprising a slider and a suspension interconnect;

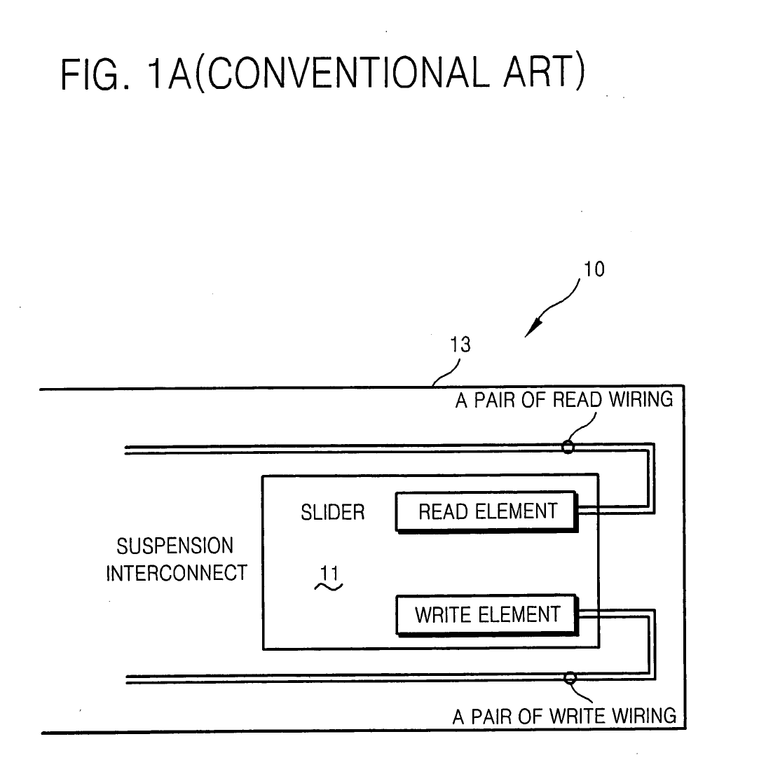

FIG. 1B shows an equivalent circuit diagram of the head gimbal assembly shown in FIG. 1A;

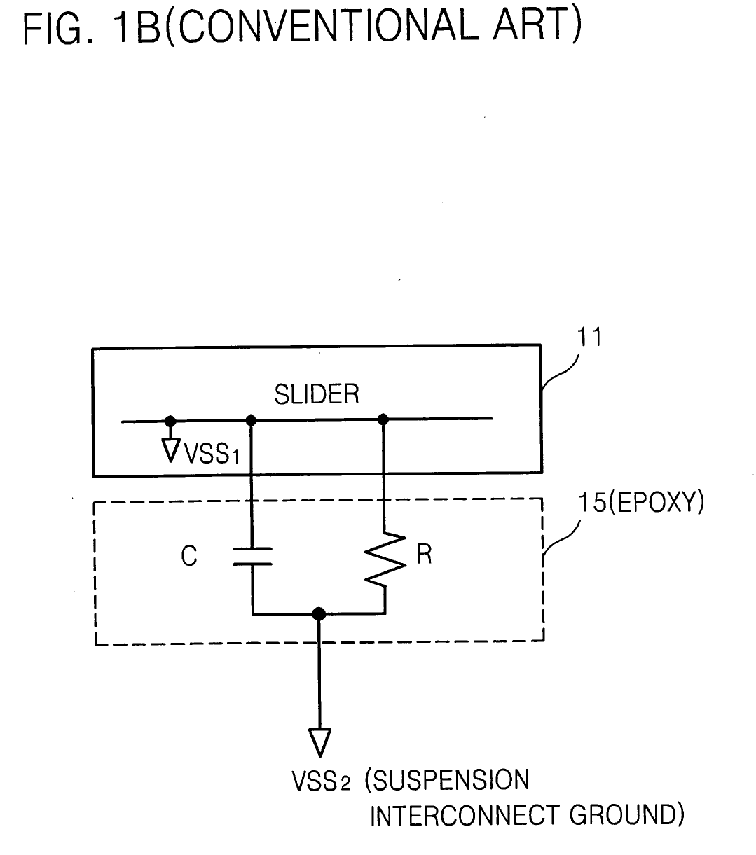

FIG. 2A schematically shows the structure of a conventional head gimbal assembly comprising a slider and a suspension interconnect;

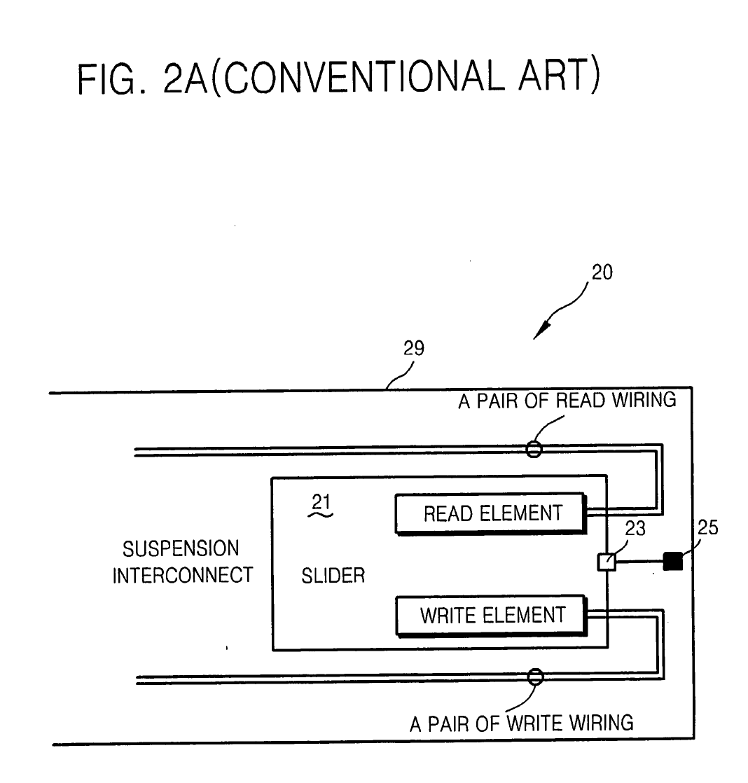

FIG. 2B shows an equivalent circuit diagram of the head gimbal assembly shown in FIG. 2A;

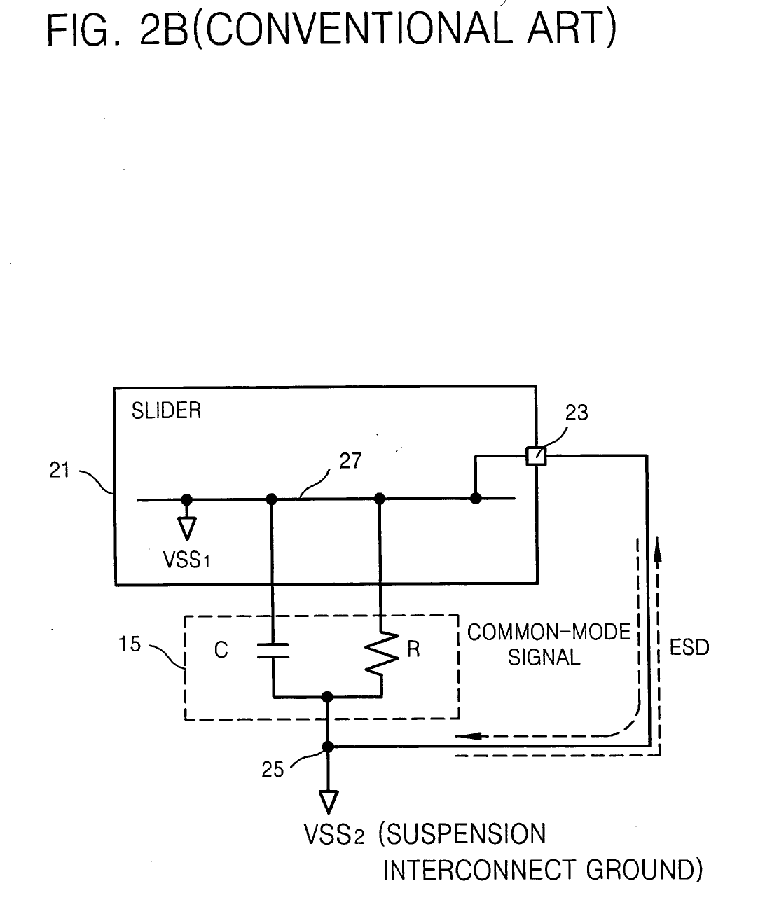

FIG. 3A shows a block diagram of a slider according to an embodiment of the present invention;

FIG. 3B schematically shows the structure of a head gimbal assembly using the slider shown in FIG. 3A according to a first embodiment of the present invention;

FIG. 3C shows an equivalent circuit diagram of the head gimbal assembly shown in FIG. 3B;

FIG. 4A schematically shows the structure of a head gimbal assembly comprising a slider and a suspension interconnect according to a second embodiment of the present invention;

FIG. 4B shows an equivalent circuit diagram of the head gimbal assembly shown in FIG. 4A;

FIG. 5A schematically shows the structure of a head gimbal according to a third embodiment of the present invention;

FIG. 5B shows an equivalent circuit diagram of the head gimbal assembly shown in FIG. 5A;

FIG. 6A schematically shows the structure of a head gimbal assembly according to a forth embodiment of the present invention;

FIG. 6B shows an equivalent circuit diagram of the head gimbal assembly shown in FIG. 6A; and

FIG. 7 shows a plane view of a hard disc drive using the head gimbal assembly according to any one of the first to forth embodiments of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

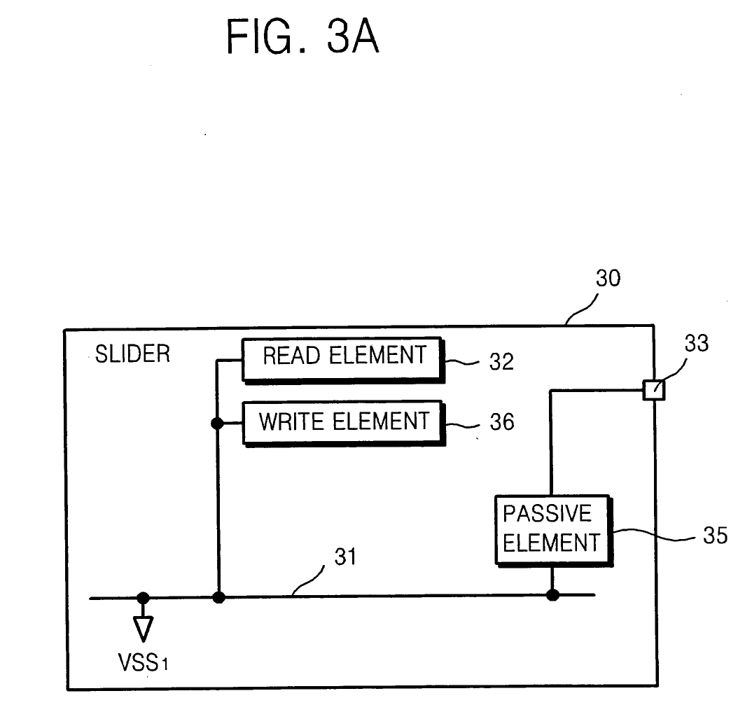

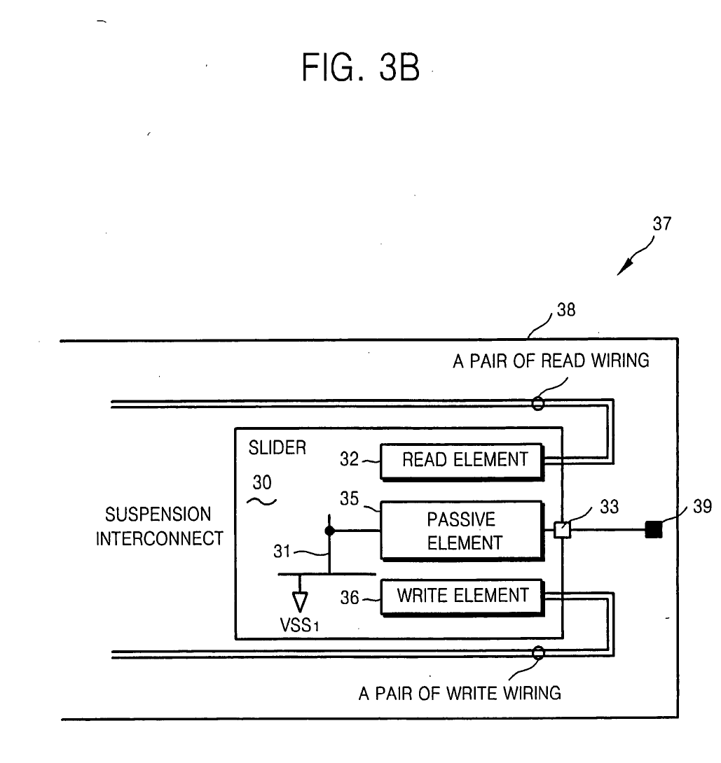

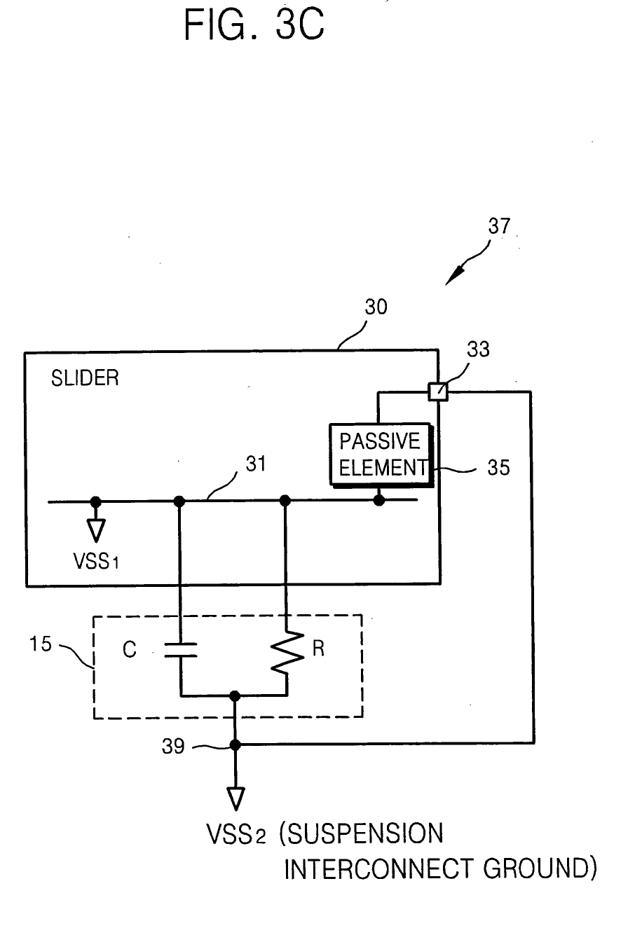

FIG. 3A shows a block diagram of a slider according to an embodiment of the present invention, FIG. 3B schematically shows the structure of a head gimbal assembly using the slider shown in FIG. 3A according to a first embodiment of the present invention, and FIG. 3C shows an equivalent circuit diagram of the head gimbal assembly shown in FIG. 3B. Referring to FIGS. 3A to 3C, the slider 30 according to an embodiment of the present invention comprises a write element 36 for writing a predetermined data on a disc, a read element 32 for reading an predetermined data written on the disc, a slider ground wire 31, a connection pad 33, and a passive element 35.

A slider ground voltage VSS1 is supplied to the write element 36 and the read element 32 through the slider ground wire 31 within the slider 30. The connection pad 33 is connected to a ground pad 39 for supplying a ground voltage VSS2 of a suspension interconnect 38 through a predetermined wiring. The passive element 35 is connected between the slider ground wire 31 and the connection pad 33. The passive element 35 may include, by way of non-limiting examples, a capacitor, a resistor, a capacitor and resistor connected in series or a capacitor and a resistor connected in parallel.

When the passive element 35 is formed of one capacitor, high frequency common-mode signals of AC components are delivered to the ground pad 39 of the suspension interconnect 38 through the capacitor and the connection pad 33. Therefore, EMI is attenuated. Meanwhile, ESD such as noise of DC components and noise of low frequency components inputted through the ground pad 39 of the suspension interconnect 38 is blocked by the capacitor and thus is not delivered to the slider 30, particularly the read element 32. Therefore, ESD immunity of the slider 30 is increased.

Also, when the passive element 35 is formed of one resistor, common-mode signals are attenuated while passing through the resistor and the connection pad 33 and external noise inputted through the ground pad 39 of the suspension interconnect 38 is delivered to the slider 30, particularly the read element 32, through the resistor, whereby the amount and transmission speed of the external noise are remarkably reduced. Therefore, influence of the external noise supplied to the slider 30 is considerably attenuated.

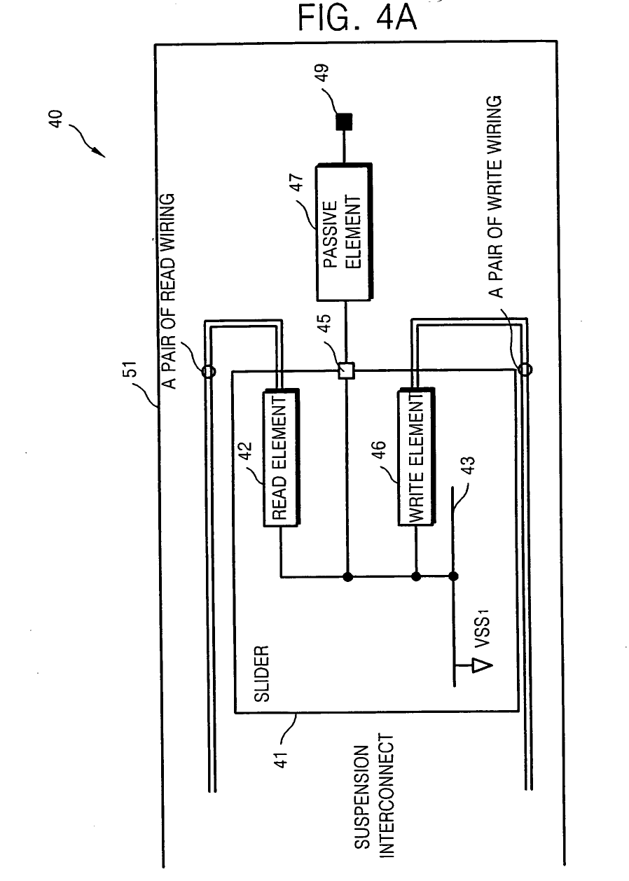

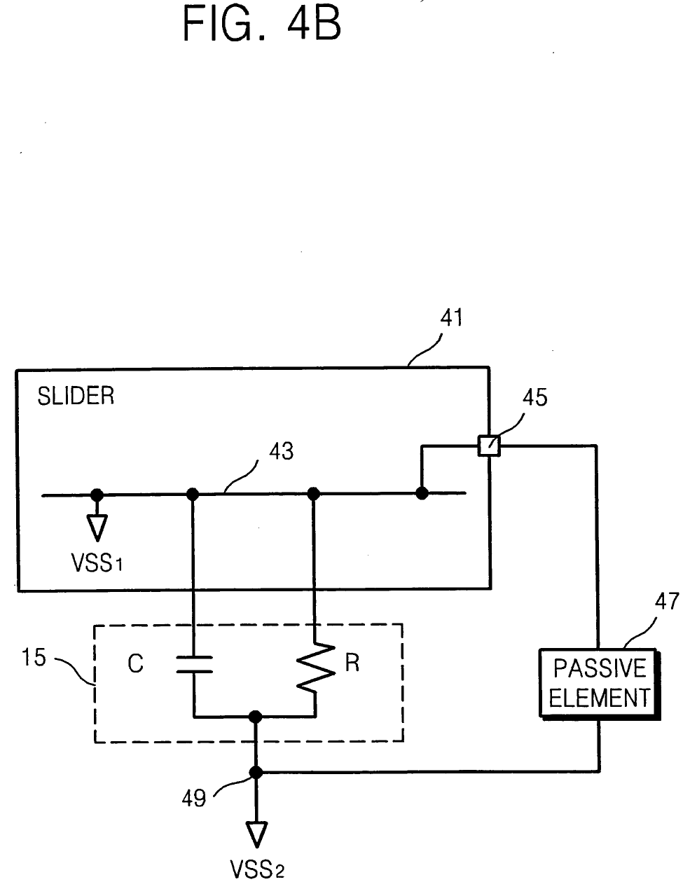

FIG. 4A schematically shows the structure of a head gimbal assembly comprising a slider and a suspension interconnect according to a second embodiment of the present invention and FIG. 4B shows an equivalent circuit diagram of the head gimbal assembly shown in FIG. 4A.

Referring to FIGS. 4A and 4B, a slider 41 and a suspension interconnect 51 of a head gimbal assembly 40 are connected through a conductive epoxy 15.

The slider 41 comprises a write element, a read element, a ground wire 43 used as a signal return path of the read,element 42 and the write element 46, and a connection pad 45. The ground wire 43 and the connection pad 45 are connected through a conductive wiring.

The suspension interconnect 51 comprises at lease one pair of read wirings connected to the read element of the slider 41, at least one pair of write wirings connected to the write element of the slider 41, a passive element 47 and a ground pad 49. The passive element 47 is connected between the connection pad 45 of the slider 41 and the ground pad 49 of the suspension interconnect 51. The passive element 47 may include, by way of non-limiting examples, a capacitor, a resistor, a capacitor and resistor connected in series or a capacitor and a resistor connected in parallel. The ground pad 49 supplies a suspension interconnect ground voltage VSS2.

The passive element 47 is formed of one capacitor, common-mode signals are delivered to the ground pad 49 of the suspension interconnect 51 through the capacitor. Therefore, EMI is attenuated. Meanwhile, ESD such as DC noise and noise of low frequency components inputted through the ground pad 49 of the suspension interconnect 51 is blocked by the capacitor and thus, is not delivered to the slider 30, particularly the read element 42.

When the passive element 47 is formed of one resistor, common-mode signals are attenuated while passing through the resistor and external noise inputted through the ground pad 49 of the suspension interconnect 51 is delivered to the slider 30, particularly the read element, through the resistor, whereby the amount and transmission speed of the external noise are reduced.

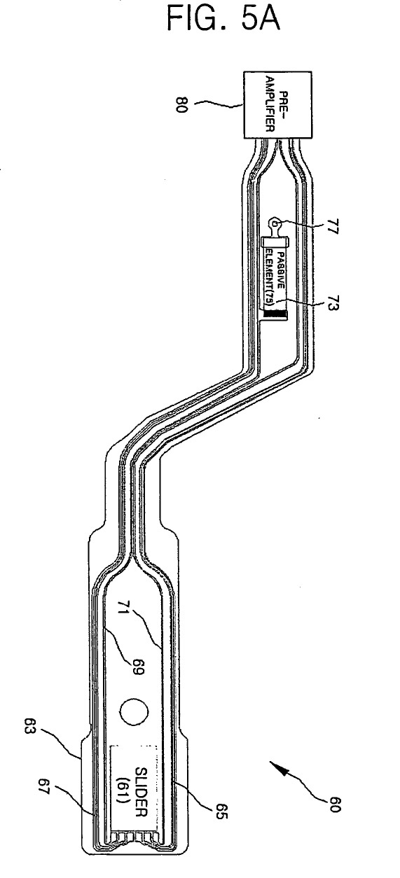

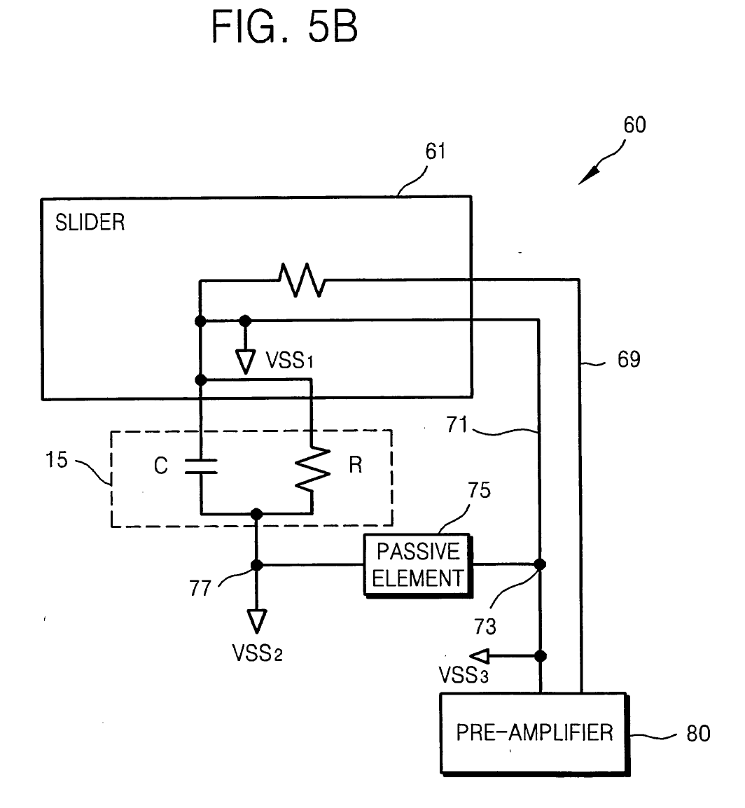

FIG. 5A schematically shows the structure of a head gimbal according to a third embodiment of the present invention and FIG. 5B shows an equivalent circuit diagram of the head gimbal assembly shown in FIG. 5A.

Referring to FIG. 5A and FIG. 5B, a head gimbal assembly 60 comprises a slider 61 including a read element (not shown), a write element (not shown) and connection pad (not shown), a suspension interconnect 63, and a pre-amplifier 80. For convenience of explanation only, in FIG. 5A, the head gimbal assembly 60 is shown and described to comprise only the slider 61, the suspension interconnect 63, and the pre-amplifier 80.

The suspension interconnect 63 comprises at least one pair of read wirings 65 connected to the read element of the slider 61, at least one pair of write wirings 67 connected to the write element of the slider 61, a resistance wire 69, a ground wire 71, a node 73, a passive element 75, and a ground pad 77. Preferably, the resistance wire 69 is a resistance wire for a FOD (flying height on demand) or DSA (dual servo actuator) and the ground wire 71 is a ground wire for the FOD or DSA.

The passive element 75 may include, by way of non-limiting examples, a capacitor, a resistor, a capacitor and a resistor connected in series or a capacitor and a resistor connected in parallel.

The ground wire 71 and the node 73 are connected to a ground wire for supplying a pre-amplifier ground voltage VSS3 to a pre-amplifier 80. The passive element 75 is connected between the node 73 and the ground pad 77 of the suspension interconnect 63. A ground voltage VSS2 of the suspension interconnect 63 is supplied through the ground pad 77.

The pre-amplifier 80 amplifies data read by the read element of the slider 61 and transmit signals amplified for writing to the write element of the slider 61. The passive element 75 emits EMI to the ground pad 77 and blocks ESD, thereby increasing ESD immunity of the read element of the slider 91.

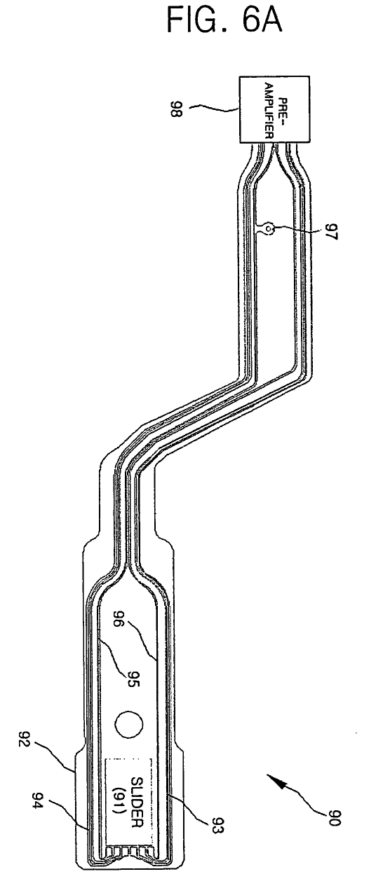

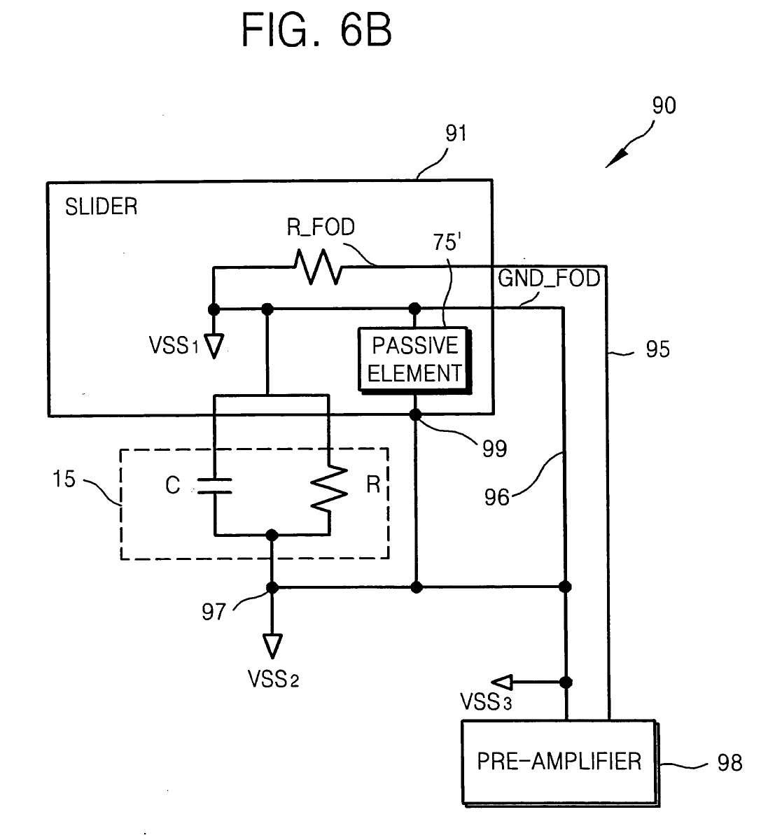

FIG. 6A schematically shows the structure of a head gimbal assembly according to a forth embodiment of the present invention and FIG. 6B shows an equivalent circuit diagram of the head gimbal assembly shown in FIG. 6A.

Contrasting FIG. 5A and FIG. 6A, the passive element 75 of the head gimbal assembly 60 shown in FIG. 5A is provided in the suspension interconnect 63 while a passive element 75′ of a head gimbal assembly 90 shown in FIG. 6A is provided in a slider 91.

Referring to FIGS. 6A and 6B, the slider 91 comprises a read element (not shown), a write element (not shown), a first connection pad (not shown) (for example, a connection pad called “a fifth pad”), a second connection pad 99, and the passive element 75′. The passive element 75′ is connected between a ground wire of the slider 91 and the second connection pad 99. The passive element 75′ may be formed of a capacitor and/or a resistor.

The second connection pad 99 is connected to a ground pad 97 of a suspension interconnect 92, a ground wire 96 for supplying a ground voltage VSS3 to a pre-amplifier 98 and the first connection pad of the slider 91. The ground wire 96 may be used as a FOD ground wire. The passive element 75′ emits EMI to the ground pad 97 and blocks ESD, thereby increasing ESD resistance of the read element of the slider 91.

The suspension interconnect 92 comprises at least one pair of read wirings 93 connected to the read element of the slider 91, at least one pair of write wirings 94 connected to the write element of the slider 91, a resistance wire 95, the ground wire 96, and the ground pad 97.

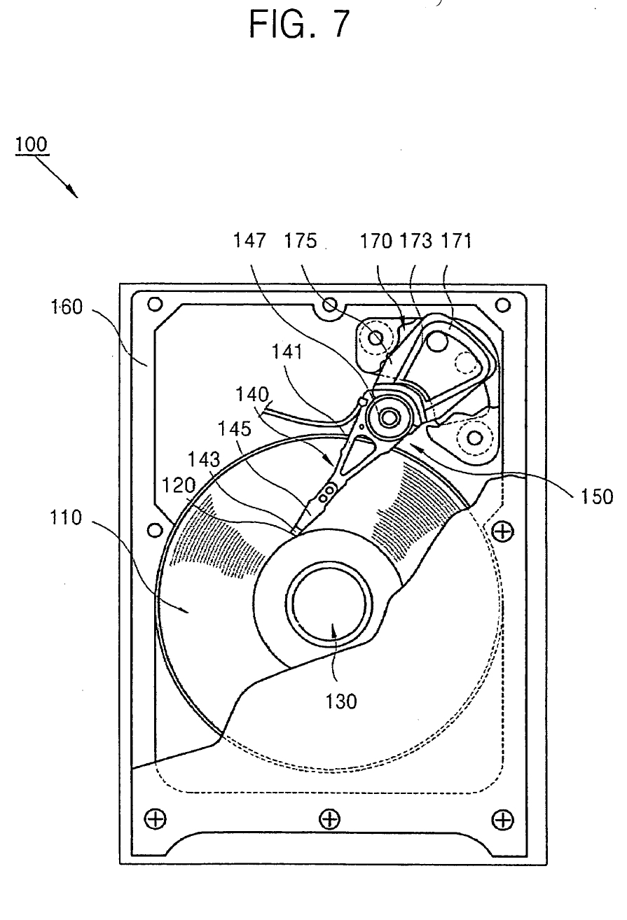

FIG. 7 shows a plane view of a hard disc drive using the head gimbal assembly according to an embodiment of the present invention.

Referring to FIG. 7, the hard disc drive 100 according to the present invention comprises a disc 110, a magnetic head 120, a spindle motor 130, a head gimbal assembly 150, and a base 160.

The disc 110 records/stores data and the magnetic head 120 comprising a write element and a read element records data on the disc 110 or reads data recorded on the disc 110. The spindle motor 130 rotates the disc 110 and the head gimbal assembly 150 comprises the magnetic head 120, a suspension interconnect 145 and an actuator 140 for flying the magnetic head 120 so that the magnetic head 120 can access data of the disc 110. The spindle motor 130 is mounted on the base 160.

The actuator 140 revolves around a shaft 147 by a voice coil motor 170. The voice coil motor 170 comprises a voice coil 173 wound around a bobbin 171 and a magnet 175 for generating magnetic field lines. The actuator 140 revolves based on the magnetic force generated by the Interaction between the magnetic field lines generated by the magnet 175 and an electric current flowing through the voice coil 173.

The actuator 140 comprises an actuator arm 141 bonded to the shaft 147, a slider 143 according to the present invention, on which the magnetic head 120 is mounted, and the suspension interconnect 145 according to the present invention, which is installed on the actuator arm 141 to support the slider 143 resiliently bias to the surface of the disc 110. The head gimbal assembly 150 according to the present invention comprises the slider 143, the suspension interconnect 145 and a pre-amplifier (not shown).

According to the above-described embodiments of the present invention, in the slider equipped with a passive element, the head gimbal assembly equipped with the slider or the passive element, and the hard disc drive equipped with the head gimbal assembly may advantageously attenuate EMI generated by common-mode noise and be strong against ESD generated by low frequency components.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A slider comprising:
a ground wire;
a connection pad connected to a ground pad of a suspension interconnect; and
a passive element connected between the ground wire and the connection pad.

2. The slider of claim 1, wherein the passive element comprises a capacitor and/or a resistor.

3. A head gimbal assembly comprising:
a suspension interconnect comprising at least one pair of write wirings, at least one pair of read wirings, and a ground pad supplying a suspension ground voltage; and
a slider comprising a write element connected to the at least one pair of write wirings, a read element connected to the at least one pair of read wirings, a connection pad connected to the ground pad, a ground wire supplying a slider ground voltage, and a passive element connected between the ground wire and the connection pad.

4. The head gimbal assembly of claim 3, wherein the passive element comprises a capacitor or a resistor.

5. A head gimbal assembly comprising:
a suspension interconnect comprising at least one pair of write wirings, at least one pair of read wirings, and a ground pad supplying a suspension ground voltage;
a slider comprising a write element connected to the at least one pair of write wirings, a read element connected to the at least one pair of read wirings, a ground wire supplying a slider ground voltage, and a connection pad connected to the ground wire; and
a passive element connected between the ground pad and the connection pad.

6. The head gimbal assembly of claim 5, wherein the passive element comprises at least one of a resistor and a capacitor.

7. The head gimbal assembly of claim 5, wherein the passive element is provided in the suspension interconnect.

8. A head gimbal assembly comprising:
a pre-amplifier ground wire supplying a pre-amplifier ground voltage to a pre-amplifier;
a suspension interconnect comprising a write wiring, a read wiring, and a ground pad supplying a suspension ground voltage;
a slider comprising a write element connected to the write wiring, a read element connected to the read wiring, a slider ground wire supplying a slider ground voltage, and a connection pad connected to the pre-amplifier ground wire and the slider ground wire; and
a passive element connected between the ground pad and the connection pad, wherein the pre-amplifier amplifies data read by the read element and transmits signals amplified for writing to the write element.

9. The head gimbal assembly of claim 8, wherein the suspension interconnect further comprises a FOD (flying height on demand) ground wire or a DSA (Dual servo actuator) ground wire, wherein the FOD ground wire or the DSA ground wire is connected to the connection pad.

10. The head gimbal assembly of claim 8, wherein the passive element comprises a capacitor or a resistor.

11. A head gimbal assembly comprising:
a pre-amplifier ground wire supplying a pre-amplifier ground voltage to a pre-amplifier;
a suspension interconnect comprising a write wiring, a read wiring, and a ground pad supplying a suspension ground voltage; and
a slider comprising a write element connected to the write wiring, a read element connected to the read wiring, a slider ground wire supplying a slider ground voltage, a first connection pad connected to the pre-amplifier ground wire and the slider ground wire, a second connection pad connected to the pre-amplifier ground wire, and a passive element connected between the slider ground wire and the second connection pad,
wherein the pre-amplifier amplifies data read by the read element and transmits signals amplified for writing to the write element.

12. A hard disc drive comprising
a disc, and
a slider comprising a read element reading data recorded on the disc, a write element recording data on the disc, a ground wire, a connection pad connected to a ground pad of a suspension interconnect, and a passive element connected between the ground wire and the connection pad.

13. The hard disc drive of claim 12, wherein the passive element comprises a resistor and/or a capacitor.

14. A hard disc drive comprising a disc and a head gimbal assembly, the head gimbal assembly comprising:
a suspension interconnect comprising at least one pair of write wirings, at least one pair of read wirings, and a ground pad supplying a ground voltage; and
a slider comprising a read element connected to the at least one pair of read wirings, a write element connected to the at least one pair of write wirings, and a connection pad connected to the ground pad of the suspension interconnect, a ground wire for supplying a slider ground voltage, and a passive element connected between the ground wire and the connection pad of the slider.

15. The hard disc drive of claim 14, wherein the passive element comprises a resistor and/or a capacitor.

16. A hard disc drive comprising a disc and a head gimbal assembly, the head gimbal assembly comprising:
a suspension interconnect comprising at least one pair of write wirings, at least one pair of read wirings, and a ground pad supplying a suspension interconnect ground voltage;
a slider comprising a write element connected to the at least one pair of write wirings, a read element connected to the at least one pair of read wirings, and a connection pad connected to a slider ground pad of the suspension interconnect; and
a passive element connected between the ground pad of the suspension interconnect and the connection pad,
wherein the passive element is disposed in the suspension interconnect.

17. A hard disc drive comprising:
a disc; and
a head gimbal assembly comprising
a pre-amplifier ground wire supplying a pre-amplifier ground voltage to a pre-amplifier,
a suspension interconnect comprising a write wiring, a read wiring, and a ground pad supplying a suspension ground voltage,
a slider comprising a write element connected to the write wiring for recording data in the disc, a read element connected to the read wiring for reading data recorded in the disc, a slider ground wire supplying a slider ground voltage, and a connection pad connected to the pre-amplifier ground wire and the slider ground wire, and
a passive element disposed in the suspension interconnect and connected between the ground pad and the connection pad,
wherein the pre-amplifier amplifies data read by the read element and transmits signals amplified for writing to the write element.

18. A hard disc drive comprising:
a disc; and
a head gimbal assembly comprising
a pre-amplifier ground wire supplying a pre-amplifier ground voltage to a pre-amplifier,
a suspension interconnect comprising a write wiring, a read wiring, and a ground pad for supplying a suspension ground voltage, and
a slider comprising a write element connected to the write wiring for recording data in the disc, a read element connected to the read wiring for reading data recorded in the disc, a slider ground wire supplying a slider ground voltage, a first connection pad connected to the pre-amplifier ground wire and the slider ground wire, a second connection pad connected to the pre-amplifier ground wire, and a passive element connected between the slider ground wire and the second connection pad,
wherein the pre-amplifier amplifies data read by the read element and transmits signals amplified for writing to the write element.
